(19) United States
(12) Patent Application Publication
(10) Pub. No.: US 2007/0265905 A1
(43) Pub. Date: Nov. 15, 2007

(54) AGENT FOR DISCOVERING RELEVANT CONTENT

(75) Inventor: Ariel J. Lazier, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/382,507

(22) Filed: May 10, 2006

(51) Int. Cl. G06F 17/30

(52) U.S. Cl. 705/10

(57) ABSTRACT

Systems and methods for identifying content relating to a user's interest. A user profile containing criteria for identifying content of interest to the user is generated. Items of relevant content are identified using the user profile and are published to the user through a user interface. The items are monitored, and the user is notified of changes to the items.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Many people depend on the Internet to gather information for making decisions that may influence their lives. Long gone are the days when people connected to the Internet primarily for quicker access to the information that was otherwise available through slower means. There is now more information available only from the Internet than any other time, and such is a prevailing trend likely to continue and to grow. For example, the ability to conduct efficient and intelligent searches has become a precious commodity itself.

Currently, Internet search engines provide a means for users to find content based on one or more keywords related to a topic of interest. In addition, technologies such as rich site summaries (RSS), blog and podcast subscriptions, search subscriptions, and email alerts are currently available for providing means for content providers to push new content to users. For example, a user can issue a search in a blog and subscribe to that search. When new blog results match the search, the results may be published to the user. Other popular technologies allow users to pull new content from content sources. For example, news aggregators can help retrieve syndicated web content published through mass media websites such as blogs and podcasts. News aggregators can help reduce the time and effort needed to regularly check websites for updates. Using news aggregators, users may subscribe to web feeds, check for new content, and gain access to a consolidated view of the content.

Existing content discovery methods, however, require a user to actively seek new content. In other words, existing technologies still depend primarily, if not solely, on user inputs. For instance, existing technologies are not capable of intelligent searching that reaches beyond a user's explicit instructions. Internet search also often takes a considerable amount of time and effort. Moreover, once a search is complete, a user must sort through and absorb the search result. Therefore, a user's ability to search and access content of interest may be limited by the user's knowledge and experience, as well as the amount of time and effort available for content discovery.

### SUMMARY OF THE INVENTION

The present invention meets the above needs and overcomes one or more deficiencies in the prior art by providing systems and methods for identifying and publishing items of content that are of interest to a user. In one embodiment, a method for identifying content relating to a user's interests is provided. A user profile is created and updated using information about the user, such as the user's search and browsing history. Using the profile, sources of content are identified. For example, the identified sources of content may be web sites and blogs that are of interest to the user. Relevant items of content from these content sources are published to the user, and these items may be monitored to detect any changes to the relevant items.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing system environment suitable for use in implementing the present invention;

FIG. 2 is a block diagram illustrating a system in accordance with one embodiment of the present invention for providing a web service for content discovery;

FIG. 3 is a block diagram illustrating a system in accordance with one embodiment of the present invention for content discovery;

FIG. 4 illustrates a method in accordance with one embodiment of the present invention for providing a web service for content discovery;

FIG. 5 is a schematic diagram illustrating a system in accordance with one embodiment of the present invention for providing and receiving a web service for content discovery;

FIG. 6 illustrates a method in accordance with one embodiment of the present invention for providing notification when new content is discovered; and

FIG. 7 illustrates a method in accordance with one embodiment of the present invention for updating user profiles.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

The present invention provides a system and methods for creating and providing an agent for content discovery. An exemplary operating environment for the present invention is described below.

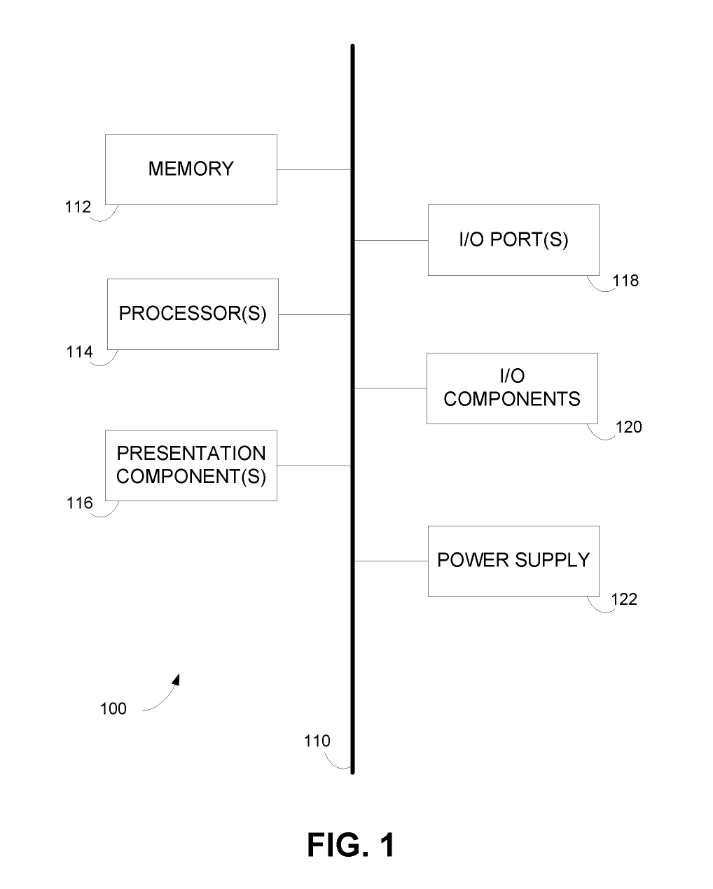

Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an 1/0 component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

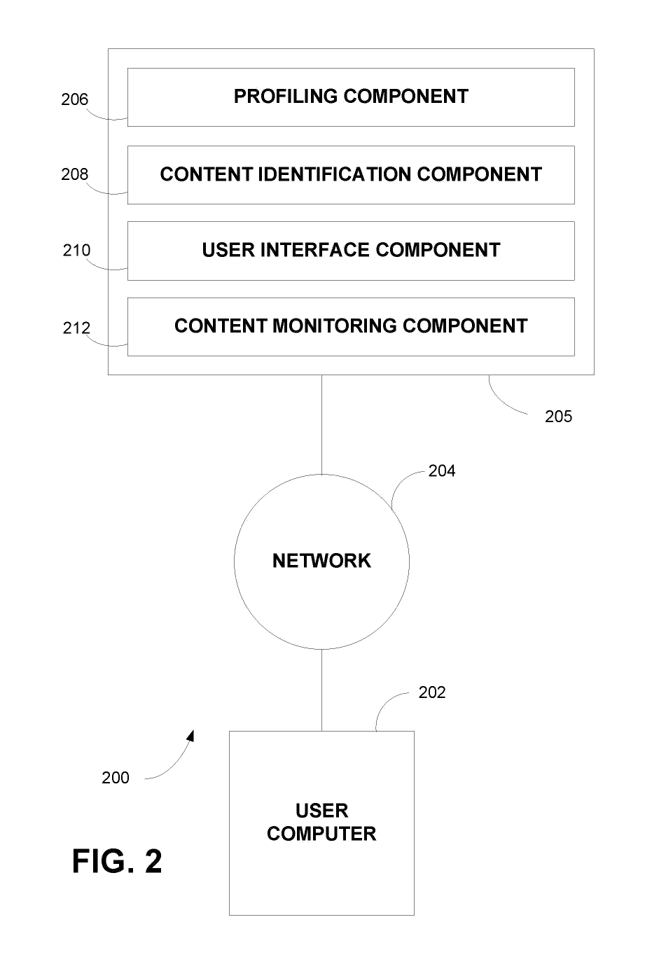

FIG. 2 illustrates a system 200 for providing a web service for content discovery to a user. The system includes a user computer 202, which is connected to a network 204. The network 204, for example, may be the Internet.

The system 200 includes a content manager 205. The content manger 205 includes a profiling component 206 that is configured to generate a user profile by utilizing sources that contain information about the user. The profiling component 206 may learn of the user's interests by inspecting the user's Internet browsing history or Internet search history. Other sources such as, but not limited to, the user's online purchasing record, email messages that the user has received and transmitted, or text and multimedia files that the user has created or downloaded from the Internet may also be utilized. For instance, if a user bookmarks and visits one or more web sites that publish classical compositions and frequently purchases and downloads audio files that contain classical compositions by Bach, the profiling component 206 may learn that classic is the user's favorite musical genre and that the user's favorite classical composer is Bach.

The profiling component 206 is also configured to update the user profile when a change to the sources is detected. The profiling component 206 may, for example, constantly inspect the sources between set intervals in order to detect the user's changing and shifting interests. For instance, if the user begins purchasing and downloading audio files that contain classical compositions by Beethoven instead of or along with those by Bach, the profiling component 206 can determine that either the user's favorite composer has become Beethoven or that the user has expanded his musical interests.

The profiling component 206 can also fine-tune the user profile by seeking comments or levels of satisfaction from the user with regard to the items that have been discovered based on the information about the user contained in the user profile. For instance, if the user provides comments that audio files containing classical compositions in one particular file format takes too long to download or carries poor sound quality, the profiling component 206 may update the user profile such that audio files in the particular file format may be either given very low publishing priority or eliminated from content discovery altogether.

The content manager 205 also includes a content identification component 208 that identifies items relevant to a user's interests based on the user's interests. The content identification component 208 learns of the user's interests from the user's profile. For instance, the content identification component 208 conducts searches and subscribes to relevant sites and blogs in order to collect the relevant items of the user's interests. Returning to the audio files example, if it is determined that the user is deeply interested in classical compositions by Bach, the content identifier component 208 searches for new sites that concern classical music and identifies online articles or critiques about Bach.

The content manager 205 further includes a user interface component 210. The user interface component 210 is configured to publish the relevant items that have been identified by the content identification component 208. The user interface component 210 is also configured to pass the contents of such publication to the display environment of the user computer 202. There are many ways to accomplish this task known in the art. For example, a graphical user interface of the user computer 202 having a dedicated window may be employed to post the relevant items through the dedicated window. The user interface component 210 is further configured to indicate changes to the relevant items that have been detected by the content monitoring component 212. For example, a pop up dialog window may be employed to indicate such changes separately from the originally identified relevant items. Indication of the changes in a separate display can increase the visibility of the changes, thereby sparing a user from having to make extra efforts to identify the changes.

The content manager 205 further includes a content monitoring component 212. The content monitoring component 212 is configured to monitor the relevant items that have been identified and to notify the user of any change to the relevant items when such change is detected. Returning to the audio files example, if a web site that publishes downloadable audio files begins publishing those audio files, including ones that contain compositions by Bach, in different file formats, the content monitoring component 212 would notify the user of the files in new formats. An email message or instant text message may be also sent to the user's computer or hand-held device to inform the user. For example, certain handheld devices are capable of receiving emails and other ways of communication through the web.

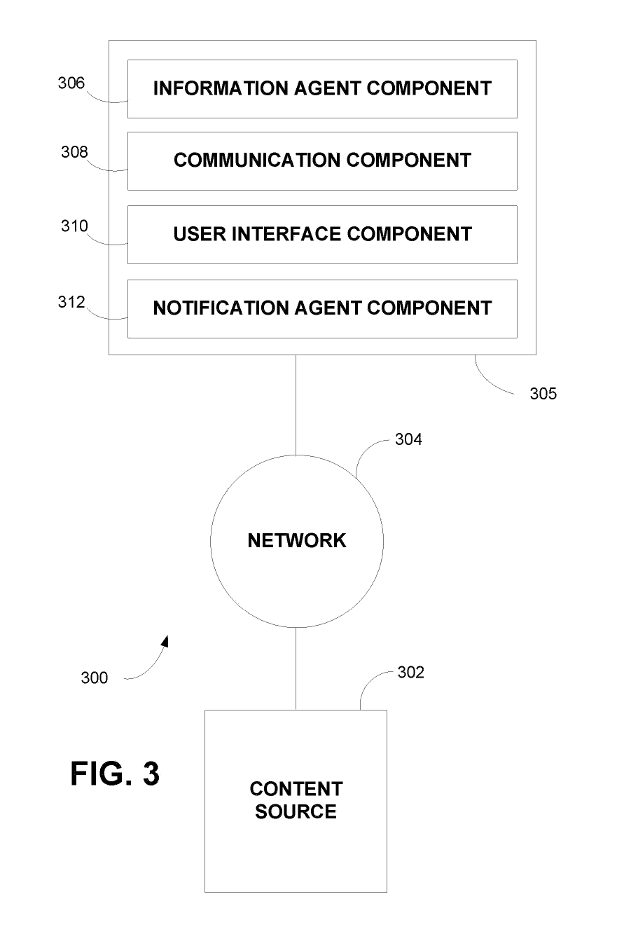

FIG. 3 is a block diagram illustrating a system 300 for content discovery from a content source 302 through a network 304. The system 300 includes a web content agent 305. The web content agent 305 includes an information agent component 306 configured to compile information about a user by utilizing sources that contain information about the user. For example, the information agent component 306 may access a user's online storages to gather information from files stored therein. For instance, the storages may contain the user's saved email messages or archived instant messenger conversations. In one embodiment, a background process may be spawned to regularly access and inspect such online storages space. The information agent component 306 may also access web sites or blogs that the user has created or participates in order to learn about the user's recent online activities and interests. The information agent component 306 is also configured to update the compilation of the user information when changes to the sources of user information are detected. For example, if the user updates content on one or more of her web sites or blogs, the information agent component 306 may be able to learn about the user's new or shifting interests from such content and may update the compilation of the user information to reflect such new or shifting interests. For instance, a background process may be spawned to regularly access and inspect the sources. The information agent component 306 may be also configured to receive comments or levels of satisfaction from the user with regard to the items discovered based on the information about the user that has been compiled.

The web content agent 305 also includes a communication component 308 that is configured to send information about a user and to receive items that are relevant to the user's interest from the content source 302. For example, the communication component 308 may issue a simple search request that contains key words that can reflect the user's interests. The communication component 308 may also transmit a complex instruction or command that may be executed in the content source 302 such as a web site or a blog to identify the relevant items through the network 304.

The web content agent 305 also includes a user interface component 310 that is configured to publish items that are relevant to a user's interests. For example, a graphical user interface having a dedicated display area may be used to display the relevant items. A text based user interface may also be used to display a list of hyperlinks for web pages containing the relevant items and descriptions thereof. The user interface component 310 may also comprise a client program that runs on the user's computer, a customizable website, or a component of another application such as, but not limited to, a RSS reader.

The web content agent 305 further includes a notification agent component 312 that is configured to notify the user when items that are relevant to a user is received by the communication component 308. For example, the user may be notified through a pop up dialog window. The user may also be notified by an email message or instant text message through the user's hand held device. The notification agent component 312 may also be configured to notify the user when the content on a personalized webpage that is tailored to the user's interest is updated. For example, such webpage may comprise multiple sections or categories in which new content may be published.

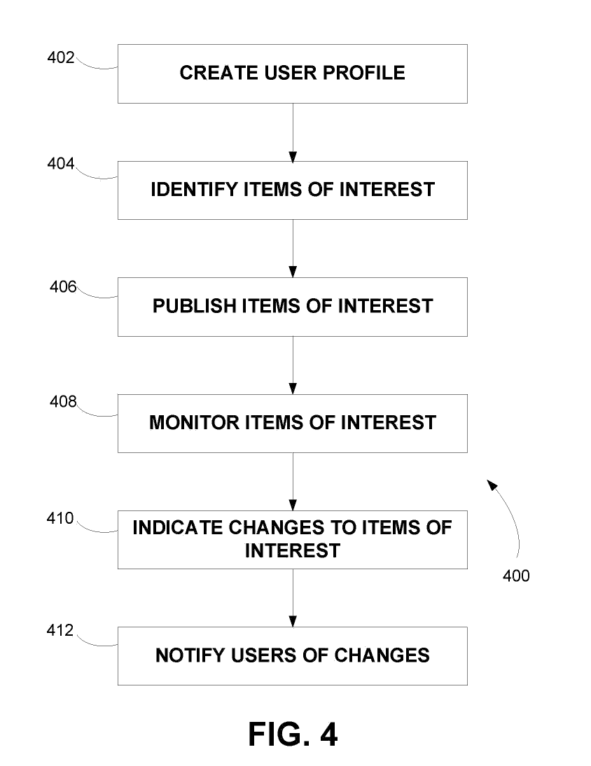

FIG. 4 illustrates a method 400 in accordance with the present invention for providing a web service for content discovery. At 402, the method 400 creates a user profile by utilizing sources that contain the user's information. The sources may be, but not limited to, the user' Internet browsing or search history, email messages or other online communications that the user has sent and received, the user's online purchasing history, and the user's online publications. At 404, the method 400 identifies items that are relevant to the user's interests by using the user profile. The relevant items may be, but not limited to, multimedia objects such as image files, audio files, or a movie clip, as well as plain text files that contain information that is of interest to the user. At 406, the method 400 publishes the relevant items through a user interface. The user interface may be a graphical user interface with a dedicated display space. It may also be a text based interface. At 408, the method 400 begins monitoring the relevant items. The method 400 may spawn one or more background process or thread to monitor the relevant items. For instance, the method 400 may revisit the web pages or blogs that contain the relevant items between set intervals. At 410, the method 400 indicates changes to the relevant items if the method 400 detects such changes. For example, the user interface may display the change separately from the relevant items. Displaying the changes in a separate display space may increase the visibility of such changes, thereby providing quicker access to the changes. At 412, the method 400 notifies the changes to the user. For example, the method 400 may pop a dialog window through the user interface. The method 400 may also send an email or a text message to the user. For example, most mobile telephones are equipped with text messaging capability these days. Handheld devices are also becoming more and more ubiquitous. As will be appreciated by those skilled in the art, a variety of means may be appropriate for communicating the changes to the user.

Advantageously, the method 400 learns of a user's interests at 402 and searches the Internet to identify items that the user may be interested, without the user's explicit request or command, at 404. The method 400 then brings the items of interests to the user's attention by publishing the items through a user interface so that the user can determine whether to access each of the items at 406. The method 400 then begins monitoring the items that have been identified in order to detect changes to any of the items at 408. As the method 400 adds more items, it can also expand the scope of the monitoring to include new items. When formats or content of any of the items change, the method 400 notifies the user of such change at 412 after indicating it in the user interface at 410. The user can save time and effort to search for items of her interests. The user can also learn about changes to such items instantly when the changes are made. Therefore, the user may be able to focus more on deciding among the relevant items that have been identified rather than spending too much time and efforts for searching and discovering such items.

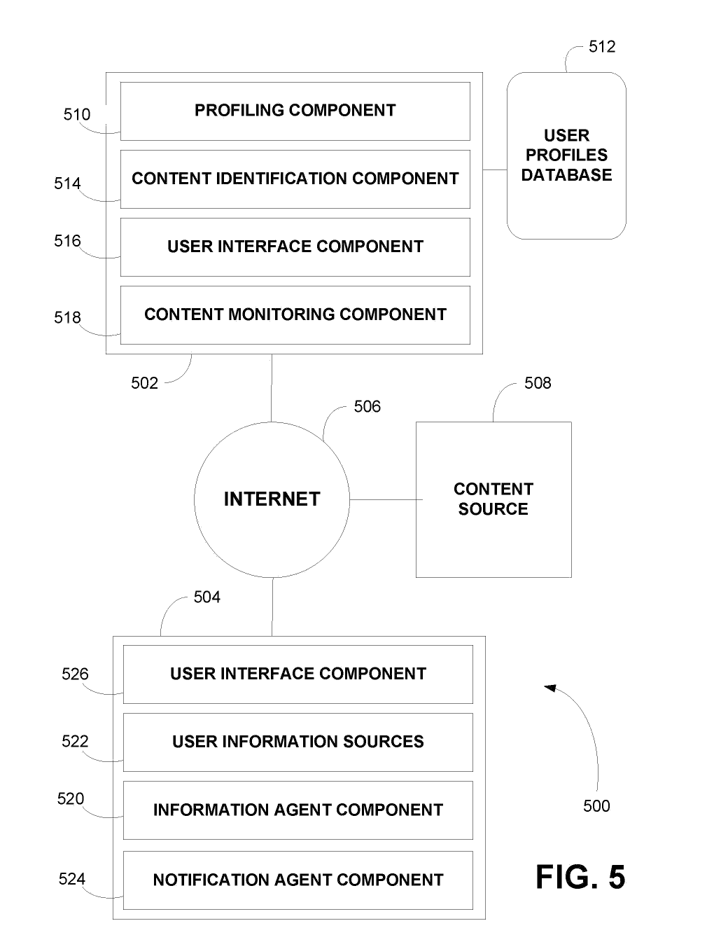

FIG. 5 is a schematic diagram illustrating a system 500 for providing and receiving a web service for content discovery. The system 500 includes a server device 502 and at least one client device 504 that communicate through the Internet 506. The server device 502 includes a profiling component 510 that is configured to generate and maintain a user profiles database 512, which contains at least one user profile. Any commercially available database management system such as Microsoft® SQL Server may be used, although a simpler database system may be suitable as well. The profiling component 510 receives information about a user from the client device 504 and generates an entry to the user profiles database 512 for the user. The profiling component 510 also receives update information associated with the profiles stored in the database 512 and updates such profiles. The server device 502 also includes a content identification component 514 that is configured to search and identify items that are relevant to a user's interests using the profile of the user. The server device 502 also includes a user interface component 516 that is configured to publish the relevant items that have been identified by the content identification component 514. There are many ways to implement such publishing in the art.

The server device 502 further includes a content monitoring component 518 that is configured to monitor the relevant items that have been identified in order to detect any change to the items. The content monitor component 518 is also configured to notify the client device 504 when such change is detected so that the client device 504 may notify the user of such change. The user interface component 516 is also configured to publish such change.

The client device 504 includes an information agent component 520 that is configured to gather and to compile user information from the user information sources 522. The user information sources may include, but not limited to a user's search or browsing history, the user's online purchasing history, online communication messages that have been sent and received by the user, and comments or levels of satisfaction that have been provided by the user with regard to the items discovered based on the user information. The information agent component 520 is also configured to communicate information about a user to the server device 502 so that a user profile can be generated for the user based on the user information. The client device 504 also includes a notification agent component 524 that is configured to receive or detect and to notify the user of information associated with changes that have been made to the relevant items from the server device 502 when such changes are detected. For example, the notification agent component may wait until it receives update information. It may also periodically access and inspect the content source 508 to detect such changes. The client device 504 further includes a user interface component 526 that is configured to publish the relevant items that have been identified for the user. The user interface component 526 is also configured to publish any change that is made to the relevant items. Such change may be displayed in a separate display space in order to help a user identify the change quickly.

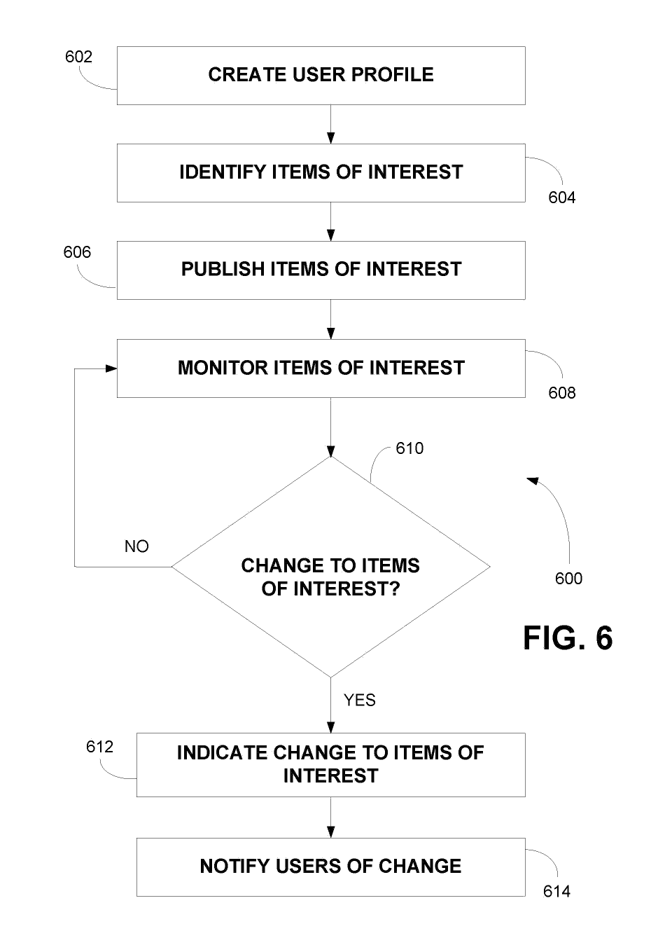

FIG. 6 illustrates a method 600 in accordance with the present invention for providing notification when new content is discovered. At 602, the method 600 creates a user profile by utilizing sources that contain information about the user. At 604, the method 600 searches and identifies items that are relevant to the user's interests using the user profile. At 606, the method 600 publishes the relevant items for the user through a user interface. At 608, the method 600 begins monitoring the relevant items that have been identified at 604. At 610, the method determines whether a change is made to any of the relevant items. If the method 600 determines that no change has been made, it returns to 608 and continues monitoring the relevant items. Steps 608 and 610 are repeated until a change is detected at 610. There are many ways to accomplish this task that are known in the art. For instance, the method 600 may spawn one or more background processes and have such background processes access and inspect the sources of the relevant items periodically. If a change is detected, the method 600 indicates such change through the user interface at 612. The method 600 also notifies the user of such change at 614.

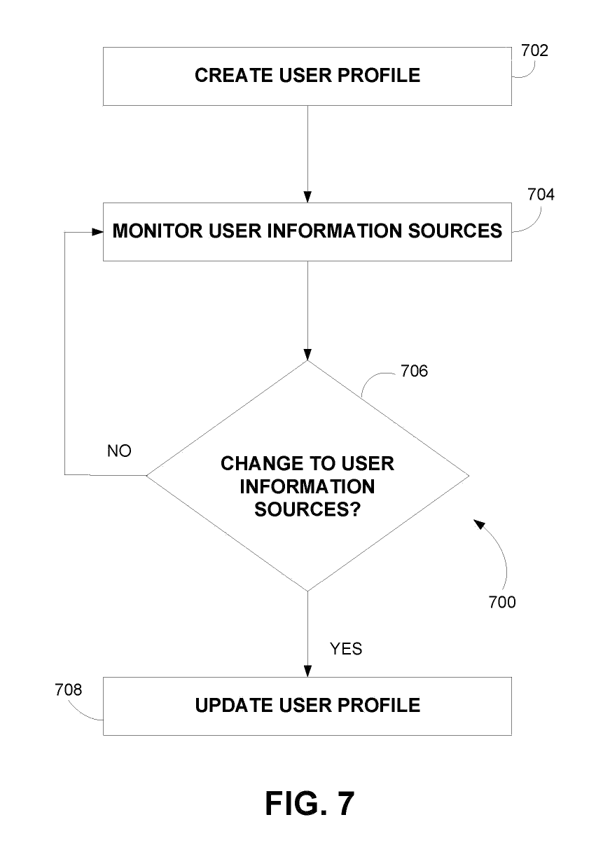

FIG. 7 illustrates a method 700 in accordance with the present invention for updating user profiles. At 702, the method 700 creates a user profile that contains criteria that can be used to identify the user's interests. The method 700 generates the user profile by utilizing sources that contain information about the user. At 704, the method 700 begins monitoring the sources that have been utilized to generate the user profile. For example, the method 700 may access the user information sources regularly to detect any change. At 706, the method 700 determines whether any change has been made to any of the sources. If the method 700 determines that there has been no change, the method 700 returns to 704 and continues monitoring the sources. Steps 704 and 706 are repeated until a change is detected. If the method 700 detects a change to any of the sources, the method 700 updates the user profile at 708. Returning to the audio files example, the method 700 may regularly inspect the user's online purchasing history to determine whether the user has recently begun purchasing and downloading audio files containing classic compositions by a different composer than Beethoven and Bach who happen to be the user's favorite composers. If the user, for instance, begins purchasing files containing compositions by Tchaikovsky as well, for instance, such expansion of the user's musical interests would be reflected in the user profile for the future reference.

Advantageously, the method 700 monitors the user information sources to detect any change that is indicative of the user's shifting or changing interests. The method 700 can intelligently predict additional new content or items of the user's interests by following the user's online communications and activities.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. A system for identifying content relating to a user's interest, the system comprising:
a profiling component (206) configured to utilize a plurality of sources to generate one or more profiles that include criteria for identifying content of interest to said user;
a content identification component (208) configured to use said one or more profiles to identify one or more items of relevant content; and
a user interface component (210) configured to publish at least a portion of said one or more items of relevant contents to said user in a user interface.

2. The system of claim 1, further comprising a content monitoring component configured to identify one or more changes to at least one of said one or more items of relevant content.

3. The system of claim 2, wherein said content monitoring component is further configured to notify said user of at least a portion of said one or more changes.

4. The system of claim 2, wherein said user interface component is further configured to indicate at least a portion of said one or more changes in said user interface.

5. The system of claim 1, wherein said profiling component is further configured to update said one or more profiles when at least one change to at least one of said plurality of sources is detected.

6. The system of claim 1, wherein said user interface is a web-based interface.

7. The system of claim 1, wherein said plurality of sources comprises one or more of:
an Internet browsing history;
a search history;
one or more emails;
one or more archived instant messenger conversations;
one or more files on a computer;
one or more files on online storage;
one or more entries in an email address book; and
a blog or a web site publication.

8. The system of claim 1, wherein said one or more items of relevant content comprise one or more of:
one or more items found on one or more web pages that said user has visited or bookmarked;
one or more items found on a web page in the same domain as at least one of said one or more web pages;
one or more items found on one or more sites that said user has visited or subscribed to;
one or more items found in one or more blogs that said user has visited or subscribed to;
one or more items found on an online calendar that said user has visited or subscribed to;
one or more items containing or referencing addresses or locations within a predetermined proximity of said user; and
one or more items published by or referencing persons associated with said user.

9. A system for publishing content relating to a user's interest, the system comprising:
an information agent component (306) configured to compile information indicating content of interest to said user, wherein said information agent component accesses a plurality of sources to compile said information;
a communication component (308) configured to receive one or more items of relevant content from a content source, wherein said information is utilized to identify at least a portion of said one or more items of relevant content; and
a user interface component (310) configured to display at least one of said one or more items of relevant content to said user in a user interface.

10. The system of claim 9, further comprising a notification agent component configured to notify said user of receipt of at least a portion of said one or more items of relevant content.

11. The system of claim 9, wherein said information agent component is further configured to update said information when one or more changes to said plurality of sources are detected.

12. The system of claim 9, wherein said communication component receives said one or more items of relevant content via the Internet.

13. The system of claim 9, wherein said plurality of sources comprises one or more of:
an indication of a browsing frequency;
an indication of a search frequency;
one or more email messages;
an indication of an online purchasing history;
one or more files on a personal computer;
one or more files on online storage;
one or more online contact lists; and
one or more online social forums memberships or participations.

14. The system of claim 9, wherein said one or more items of relevant content comprise one or more of:
one or more items found on one or more web pages that said user has visited or bookmarked;
one or more items found on at least one web page in the same domain as at least one of said one or more web pages;
one or more items found on online journals said user has visited or subscribed to; and
one or more items found in online event listings that said user has visited or subscribed to.

15. One or more computer-readable media having computer-usable instructions embodied thereon to perform a method for identifying content of interest to a user, said method comprising:
creating (402) a profile associated with said user by utilizing a plurality of sources, wherein said profile includes criteria indicating content of interest to said user;
identifying (404) one or more items of relevant content by utilizing said criteria;
publishing (406) at least a portion of said one or more items of relevant content in a user interface;
monitoring (408) at least a portion of said one or more items of relevant content to identify one or more changes to at least one of said one or more items of relevant content; and
indicating (410) at least a portion of said one or more changes in said user interface.

16. The computer-readable media of claim 15, wherein said method further comprises updating said profile when one or more changes to at least one of said plurality of sources are detected.

17. The computer-readable media of claim 15, wherein said method further comprises notifying said user of said one or more changes.

18. The computer-readable media of claim 15, wherein said user interface is provided as a website.

19. The computer-related media of claim 15, wherein said one or more items of relevant content comprise one or more of:
an indication of a browsing history;
an indication of a search history;
one or more a email messages;
one or more a archived instant messenger conversations;
an indication of an online purchasing history;
one or more files on a personal computer;
one or more files on online storage;
one or more entries from an email address book;
at least a portion of an online contact lists;
one or more blog or web site publications; and
one or more online social forums memberships or participations.

20. The computer-related media of claim 15, wherein said plurality of sources comprises one or more of:
one or more items found on one or more web pages that said user has visited or bookmarked;
one or more items found on at least one web page in the same domain as at least one of said one or more web pages;
one or more items found on one or more sites said user has visited or subscribed to;
one or more items found in one or more blogs said user has visited or subscribed to;
one or more items found on one or more online journals said user has visited or subscribed to;
one or more items found on one or more online event listings said user has visited or subscribed to;
one or more items found on one or more online calendars that said user has visited or subscribed to;
one or more items containing or referencing addresses or locations associated with said user; and
one or more items published by or referencing persons whose relations to said user are inferred from one or more joint appearances.
